(19) United States
(12) Patent Application Publication
(10) Pub. No.: US 2009/0107158 A1
(43) Pub. Date: Apr. 30, 2009

(54) AUTOMOTIVE COOLING SYSTEM

(75) Inventors: Seung Hyun Youn, Hwaseong-si (KR); Dong Won Yeon, Hwaseong-si (KR); Nak Sup Sung, Hwaseong-si (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/117,610

(22) Filed: May 8, 2008

(30) Foreign Application Priority Data
Oct. 25, 2007 (KR) 10-2007-0107785

(51) Int. Cl. B60H 1/32; F28D 5/00

(52) U.S. Cl. 62/239; 62/304

(57) ABSTRACT

An automotive cooling system, which comprises a housing, a radiator unit, and a circulating fan, is disclosed. The housing has a water tank for supplying water. The radiator unit has external air radiating fins emitting heat of vaporization of the water through a flow of air introduced from outside the vehicle, and internal air radiating fins exchanging heat with air circulating through an interior of the vehicle, and is installed on the housing. The circulating fan is installed in the housing in order to circulate the air in the interior of the vehicle.

### CROSS-REFERENCE TO RELATED APPLICATIONS

This application claims priority to Korean Application No. 10-2007-0107785, filed on Oct. 25, 2007, the disclosure of which is incorporated herein by reference.

### BACKGROUND OF THE INVENTION

1. Field of the Invention

The present invention relates to an automotive cooling system, and, more particularly, to an automotive cooling system which cools the interior of a vehicle by evaporation of water.

2. Description of the Prior Art

Vehicles are equipped with a cooling and heating apparatus, which introduces cooled or heated air into the interior of the vehicle and thereby cools or heats the interior of the vehicle in order to create a comfortable environment in the interior of the vehicle. Such a cooling and heating apparatus cools or heats the interior of the vehicle using an evaporator and a heat exchanger, such as a heater core.

However, this cooling and heating apparatus consumes a lot of energy to perform such cooling and heating. Thus, a cooling system capable of using less energy resources is required.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Accordingly, the present invention has been made keeping in mind the above problems occurring in the prior art, and an object of the present invention is to provide an automotive cooling system, with which the interior of a vehicle is cooled using the heat of vaporization of water while the vehicle is traveling.

In order to achieve the above object, according to the present invention, there is provided an automotive cooling system, which comprises a housing, a radiator unit, and a circulating fan. The housing has a water tank for supplying water and is mounted on the roof of a vehicle. The radiator unit has external air radiating fins that emit the heat of vaporization of the water through the flow of air introduced from outside the vehicle, and internal air radiating fins exchanging heat with air circulating through an interior of the vehicle, and is installed on the housing. The circulating fan is installed in the housing in order to circulate the air in the interior of the vehicle.

The automotive cooling system may further comprise an evaporating plate, which is installed between the external air radiating fins and the internal air radiating fins and exchanges heat between an external air chamber and an internal air chamber. The housing may include a door for selectively introducing the air from outside the vehicle.

According to an exemplary embodiment of the present invention, the air in the interior of the vehicle is cooled using the heat of vaporization of the water, so that the interior of the vehicle can be efficiently cooled.

### BRIEF DESCRIPTION OF THE DRAWINGS

The above and other features of the present invention will now be described in detail with reference to certain exemplary embodiments thereof illustrated the accompanying drawings which are given hereinbelow by way of illustration, and thus are not limitative of the present invention, and wherein:

FIG. 1 is a view illustrating the configuration of an automotive cooling system according to an exemplary embodiment of the present invention;

FIG. 2 is a perspective view illustrating the radiator unit of an automotive cooling system according to an exemplary embodiment of the present invention;

FIG. 3 is a view illustrating the flow of energy in an automotive cooling system according to an exemplary embodiment of the present invention;

FIG. 4 is a view illustrating the configuration of an automotive cooling system according to another embodiment of the present invention; and

FIG. 5 is a view illustrating the configuration of an automotive cooling system according to another embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DESCRIPTION OF THE PREFERRED EMBODIMENTS

Reference will now be made in detail to a preferred embodiment of the present invention, an example of which is illustrated in the accompanying drawings and described below. While the invention will be described in conjunction with an exemplary embodiment, it should be understood that the description is not intended to limit the invention to the exemplary embodiment. On the contrary, the invention is intended to cover not only the exemplary embodiment, but also various alternatives, modifications, equivalents and other embodiments, which may be included within the spirit and scope of the invention as defined by the appended claims.

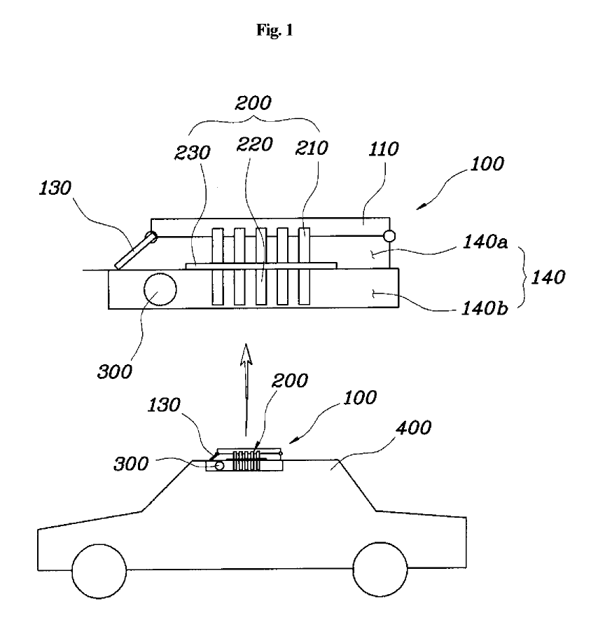

As illustrated in FIG. 1, an exemplary embodiment of the present invention comprises a housing 100, mounted at the roof 400 of a vehicle, a radiator unit 200, using the heat of vaporization of water in order to cool the interior of the vehicle, and a circulating fan 300, circulating air in the interior of the vehicle for heat exchange between the atmosphere and the interior of the vehicle.

In detail, the housing 100 includes a hollow air chamber 140, through which air flows. The hollow air chamber 140 further includes an external air chamber 140a, and an internal air chamber 140b positioned on lower side of the external air chamber 140a. The external air chamber 140a is positioned outside the vehicle and the internal air chamber 140b is positioned inside the vehicle. While the vehicle is traveling, the air outside the vehicle flows into the external air chamber 140a and the air inside the vehicle is circulated through the internal air chamber 140b in the vehicle for heat exchange.

In an exemplary embodiment of the present invention, the air in the vehicle may be circulated by the circulating fan 300 through the internal air chamber 140b. The circulating fan 300 is a fan that is operated by a driving motor and installed in the internal air chamber 140b.

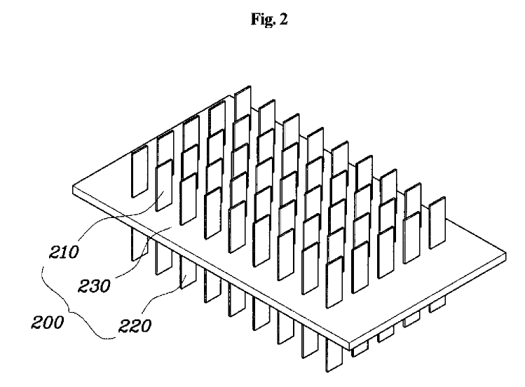

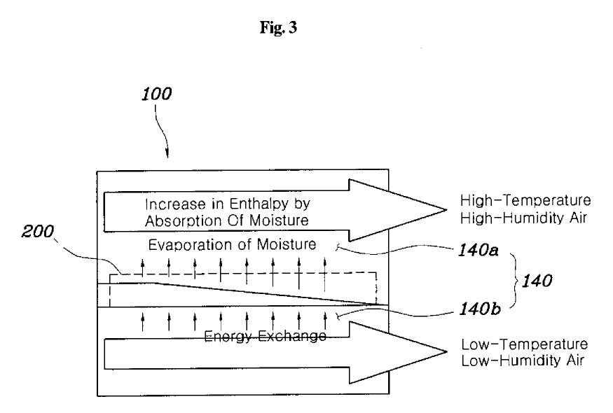

The housing 100 further includes a radiator unit 200 and a water tank 110, as illustrated in FIG. 2 or 3. The radiator unit 200 dissipates the transferred heat in the external air chamber 140 a by vaporization of the water supplied from the water tank 110 as explained in detail hereinafter.

Generally, the heat dissipation depends on the heat gradient, i.e., the temperature difference between two places. That is, the speed of heat transfer is increased as the heat gradient is increased. Therefore the larger the temperature difference between two places is, the faster the heat is transferred from a place of high temperature to a place of low temperature, and thus efficiency of heat change is increased.

Furthermore, whenever water molecules leave a surface, (i.e., evaporation), the water molecules absorb thermal energy. As a result, when a net evaporation occurs, the body of water will undergo a net cooling directly related to the loss of water. Therefore, as a wind is flown onto a water surface faster, the leaving speed of water molecule, i.e., evaporation speed is increased. Accordingly, the speed of the wind and the amount of water are the factors that determine the heat gradient for heat exchange.

To this end, an exemplary embodiment of the present invention provides the external air chamber 140 and the water tank 110.

First, the radiator unit 200, comprises at least an external-air radiating fin 210 positioned in the external air chamber 140a, at least an internal air radiating fin 220 positioned in the internal air chamber 140b, and at least an evaporating plate 230 which is interposed between the external-air radiating fins 210 and the internal-air radiating fins 220.

Lower end portions of the external-air radiating fins 210 are integrally formed on upper end portions of the internal air radiating fins 220 respectively in a perpendicular direction and the evaporating plate 230 are interposed therebetween.

Second, the water tank 110 is positioned on the external air chamber 140a of the hollow air chamber 140 and supplies water to the radiator unit 200. That is, the water tank 110 supplies water to the external air radiating fins 210 of the radiator unit 200.

Since the external air chamber 140a is disposed outside the vehicle, the air outside the vehicle flows into the external air radiating fins 210 while the vehicle is traveling. Furthermore, the water tank 110 supplies water to the external air radiating fins 220 and thus the water becomes evaporated by the flown into air to reduce the temperature of the external air radiating fins 210. At that point, the heat gradient between the external air radiating fins 210 and the internal air radiating fins 220 is increased and thus the heat inside the vehicle is transferred to the external air radiating fins 210.

The heat transferred to the external air radiating fins 210 is absorbed by the water molecules when the water is evaporated. At this time, the high-temperature, low-humidity air outside the vehicle passes through the radiator unit 200, and then is converted into high-temperature and high-humidity air. Thereafter the water molecules having high-temperature and high-humidity are flown out with the absorbed heat energy outside the vehicle.

In an exemplary embodiment of the present invention, the heat of internal-air radiating fins 220 inside the vehicle can be transmitted to the external air radiating fins 210 through the evaporating plate 230.

The evaporating plate 230 serves to transmit the heat energy between the external air radiating fins 210 and the internal air radiating fins 220. To this end, the evaporating plate 230 is preferably made of material having high thermal conductivity, for instance, aluminum, copper, iron or the like.

The shape of the evaporating plate 230 is square or rectangular, but not limited thereto and any other shape may be employed and included as long as they carry out the function of heat exchanging parts.

In order to supply the water in the water tank 110 to the radiator unit 200, the water tank 110 may be disposed above the radiator unit 200, so that the flow of water due to gravity can be taken advantage of.

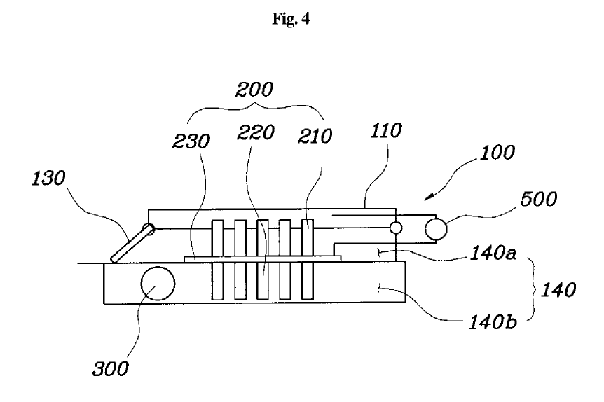

In another embodiment of the present invention, as illustrated in FIG. 4, a water pump 500 may be installed additionally, and hence the pumping force of the water pump 500 can be used in an exemplary embodiment of the present invention.

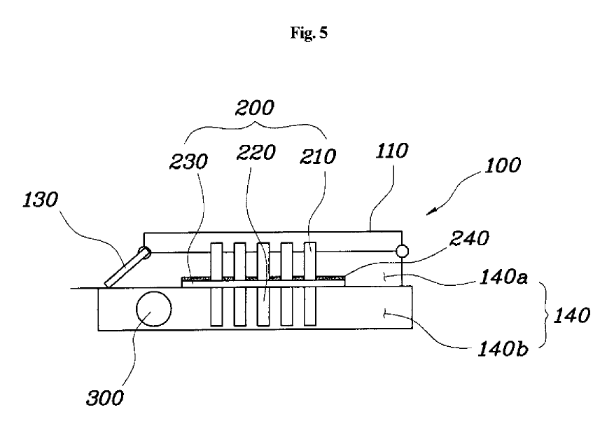

In another embodiment of the present invention, the external air chamber 140a may be a venturi-type channel wherein the input portion is wider than the middle portion. Since in the venturi-type channel, the air velocity is increased through the constriction at the middle portion, the water molecules leaves a surface, (i.e., evaporation) more rapidly, the water molecules absorb more thermal energy and thus the heat gradient is further increased. As illustrated in FIG. 5, absorbent material layer 240 may be positioned on the evaporating plate 230. The absorbent material layer 240 soaks up water easily and the water is constantly evaporated by the flown into air.

Meanwhile, the housing 100 may be provided with a door 130, which permits or blocks the introduction of air from outside the vehicle selectively. The door 130 is pivotably installed on an inlet of the housing 100, through which the air is introduced from outside the vehicle while the vehicle is traveling. This door 130 functions to open the housing 100 to introduce the air from outside the vehicle when the cooling system is operated, and closes the housing 130 to prevent the air from being introduced into the housing 100 when the cooling system is not operated.

The housing 100 according to this exemplary embodiment of the present invention is mounted on the roof 400 of the vehicle, but the invention is not limited to this configuration. Accordingly, the housing 100 may be installed at various positions of a vehicle body along which the air outside the vehicle can smoothly flow while the vehicle is traveling.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An automotive cooling system comprising:
a housing;
an external air chamber and an internal air chamber, wherein the external air chamber is on the internal air chamber; and
a radiator unit, having at least an external air radiating fin and at least an internal air radiating fin configured integrally, wherein the external air radiating fins are disposed in the external air chamber and the internal air radiating fins are disposed in the internal air chamber, and wherein the external air radiating fins emit heat of vaporization of the water by a flow of air introduced from outside a vehicle, and the internal air radiating fins transfer heat of the interior of the vehicle to the external air radiating fins by air circulation inside the vehicle.

2. The automotive cooling system according to claim 1, further comprising a water tank for supplying water to the external air radiating fins of the radiator unit;

3. The automotive cooling system according to claim 2, a water pump is installed at the water tank to supply the water.

4. The automotive cooling system according to claim 1, further comprising a circulating fan installed in the internal air chamber in order to circulate air inside the vehicle.

5. The automotive cooling system according to claim 1, wherein the external air chamber is positioned outside the vehicle and the internal air chamber is positioned inside the vehicle.

6. The automotive cooling system according to claim 1, wherein the external air chamber is a venturi-typed chamber comprising an inlet wherein the size of inlet is bigger than the size of a middle portion of the venturi-typed chamber

7. The automotive cooling system according to claim 1, further comprising an evaporating plate, which is installed between the external air radiating fins and the internal air radiating fins to exchange heat between the external air chamber and the internal air chamber.

8. The automotive cooling system according to claim 1, wherein the external air radiating fins, the internal air radiating fins and an evaporating plate are made of material having high thermal conductivity.

9. The automotive cooling system according to claim 8, wherein the material having high thermal conductivity includes aluminum, copper, or iron,

10. The automotive cooling system according to claim 1, wherein the housing includes a door for selectively introducing the air from outside the vehicle.

11. The automotive cooling system according to claim 1 the housing is mounted on a roof of the vehicle.
